(19) United States
(12) Patent Application Publication
(10) Pub. No.: US 2017/0107888 A1
(43) Pub. Date: Apr. 20, 2017

(54) EXHAUST GAS SENSOR AND OUTBOARD MOTOR ENGINE INSTALLED WITH THE SAME

(71) Applicant: SUZUKI MOTOR CORPORATION, Hamamatsu-Shi (JP)

(72) Inventors: Go MURAMATSU, Hamamatsu-Shi (JP); Masaya NISHIO, Hamamatsu-Shi (JP)

(73) Assignee: SUZUKI MOTOR CORPORATION, Hamamatsu-Shi (JP)

(21) Appl. No.: 15/278,493

(22) Filed: Sep. 28, 2016

(30) Foreign Application Priority Data
Oct. 15, 2015 (JP) 2015-203622

(51) Int. Cl. F01N 13/00; F02B 61/04

(52) U.S. Cl. CPC F01N 13/004; F01N 13/008; F02B 61/045

(57) ABSTRACT

A tubular protector provided with a basal end side installed in a casing to cover an oxygen concentration detector has a tubular portion configured to house a detecting portion of the oxygen concentration detector in a bottomed hollow formed by blocking a tip side thereof, and an extension configured to extend from a bottom of the tubular portion to a tip and provided with a plurality of channels each communicating with an inner side of the tubular portion and having an exhaust gas inlet port opened outward in a radial direction.

### CROSS-REFERENCE TO RELATED APPLICATIONS

This application is based upon and claims the benefit of priority of the prior Japanese Patent Application No. 2015-203622, filed on Oct. 15, 2015, the entire contents of which are incorporated herein by reference.

### BACKGROUND OF THE INVENTION

Field of the Invention

The present invention relates to an exhaust gas sensor and an outboard motor engine installed with the exhaust gas sensor.

Description of the Related Art

In an internal combustion engine such as a gasoline engine, an oxygen sensor as an exhaust gas sensor is provided in an exhaust pipe side of the engine to detect an oxygen concentration of the exhaust gas using the oxygen sensor. As a result, a feedback control of an air-fuel ratio of the engine can be achieved.

Depending on an engine operating environment, water is easily condensed in the exhaust pipe, and a part of the condensed water flows to the vicinity of a detecting element of the oxygen concentration. For this reason, for example, as discussed in Japanese Laid-open Patent Publication No. 2008-89611, in order to prevent the water of the exhaust gas from reaching the detecting element, the detecting element is protected from contact with the water by evaporating the moisture. This may improve a waterproof property and durability or reliability of the oxygen sensor.
Patent Document 1: Japanese Laid-open Patent Publication No. 2008-89611

In this technique of the prior art, the moisture is evaporated in order to prevent the water of the exhaust gas from reaching the detecting element. However, in case of sea water, if the moisture is evaporated, salts remain. This may generate any unexpected problem such as clogging of a vent hole around the detecting element. In this case, it is difficult to secure a proper operation of the oxygen sensor.

### SUMMARY OF THE INVENTION

In view of the aforementioned problems, it is therefore an object of the present invention to provide an exhaust gas sensor capable of providing excellent operability and constantly guaranteeing a proper operation and an outboard motor engine installed with such an exhaust gas sensor.

According to an aspect of the present invention, there is provided an exhaust gas sensor including: a casing installed in the middle of a flow path of an exhaust pipe; an oxygen concentration detector installed in the casing and configured to detect an oxygen concentration of an exhaust gas flowing through the flow path; and a tubular protector having a basal end side installed in the casing to cover the oxygen concentration detector, wherein the protector has a tubular portion configured to house a detecting portion of the oxygen concentration detector in a bottomed hollow formed by blocking a tip side of the protector, and an extension configured to extend from a bottom of the tubular portion to a tip and provided with a plurality of channels each communicating with an inner side of the tubular portion and having an exhaust gas inlet port opened outward in a radial direction.

In the exhaust gas sensor described above, the extension may have a cylindrical tip formed in a conical shape, and the inlet ports may be opened on a circumferential surface of the conical shape.

In the exhaust gas sensor according to this invention, the casing may have a male thread portion formed in an outer circumference of a stepped tubular holder of the tip side for installation in the exhaust pipe, and the protector may be provided with at least three channels in the extension.

In the exhaust gas sensor according to this invention, the protector may be detachably installed in the casing and serve as an attachment for connecting the casing and the exhaust pipe to each other.

According to another aspect of the present invention, there is provided an outboard motor engine including: a crankshaft having an axial line oriented in a vertical direction; a plurality of cylinders arranged vertically overlappingly; and an exhaust flow path formed to extend from a combustion chamber in a horizontal direction and then be bent downward for discharging an exhaust gas to water, the outboard motor engine further including an exhaust gas sensor provided with the protector which is approximately in parallel with an exhaust pipe directed downward while a tip side of the protector being directed downward in the flow path of the bend portion of the exhaust flow path.

### BRIEF DESCRIPTION OF THE DRAWINGS

FIG. 1 is a left side view schematically illustrating an exemplary configuration of an entire outboard motor according to an embodiment of the invention;

FIG. 2 is a cross-sectional view illustrating an oxygen sensor install portion and its surroundings in the outboard motor engine according to an embodiment of the invention;

FIG. 3 is a cross-sectional view illustrating an oxygen sensor installed in an exhaust passage of the outboard motor engine according to an embodiment of the invention;

FIG. 4 is a cross-sectional view illustrating an exemplary configuration of the oxygen sensor according to an embodiment of the invention;

FIG. 5A is a side view illustrating a part of a protector of the oxygen sensor according to an embodiment of the invention;

FIG. 5B is a side view illustrating a part of the protector of the oxygen sensor according to an embodiment of the invention;

FIG. 6A is a diagram illustrating an exemplary channel configuration of the oxygen sensor according to an embodiment of the invention;

FIG. 6B is a diagram illustrating an exemplary channel configuration of the oxygen sensor according to an embodiment of the invention;

FIG. 7 is a perspective view illustrating an exemplary configuration of an oxygen sensor according to a second embodiment of the invention;

FIG. 8 is a cross-sectional view illustrating an exemplary configuration of the oxygen sensor according to the second embodiment of the invention; and

FIG. 9 is a perspective view illustrating another exemplary configuration of the oxygen sensor according to the second embodiment of the invention.

### DETAILED DESCRIPTION OF THE PREFERRED EMBODIMENTS

An exhaust gas sensor and an outboard motor engine installed with the exhaust gas sensor according to preferred embodiments of the present invention will now be described with reference to the accompanying drawings.

### First Embodiment

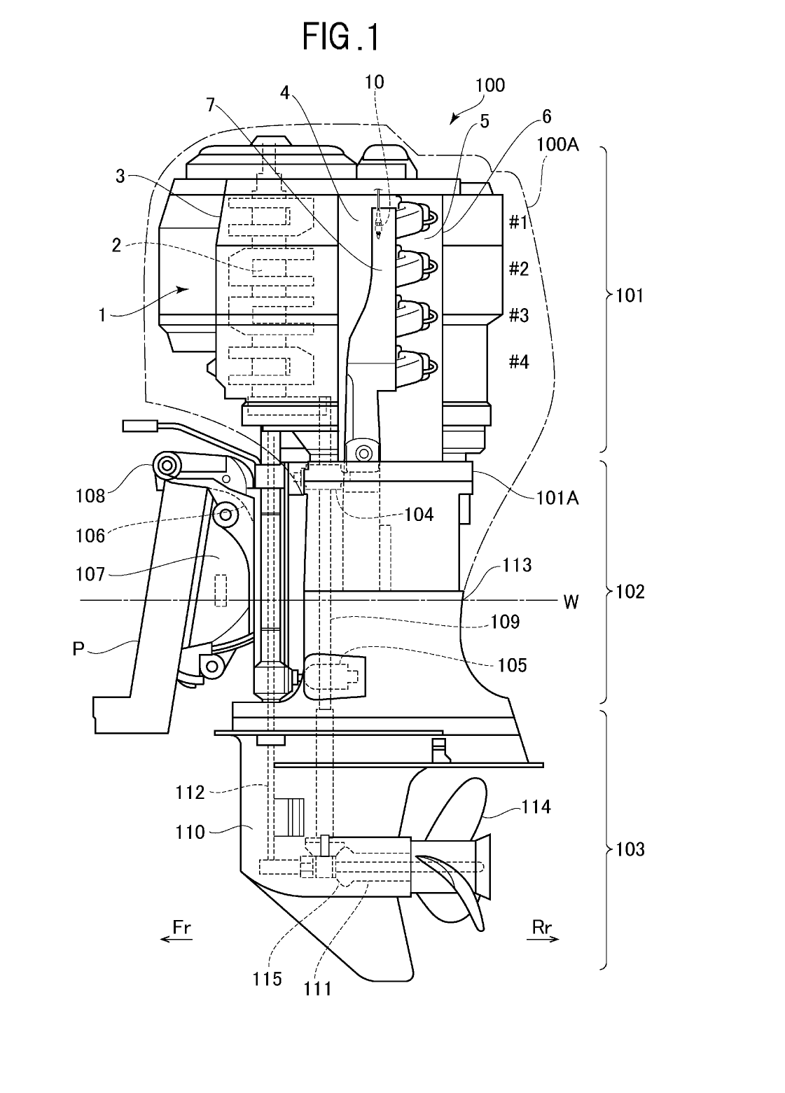

FIG. 1 is a left side view schematically illustrating an exemplary configuration of an outboard motor 100 according to the present invention. In this case, as illustrated in FIG. 1, a front part of the outboard motor 100 is fixed to a transom P of a ship hull. Note that, in each drawing of the following description, the arrow “Fr” denotes a front side of the outboard motor 100, the arrow “Rr” denotes a rear side of the outboard motor 100, the arrow “R” denotes a right side of the outboard motor 100, and the arrow “L” denotes a left side of the outboard motor 100 as necessary.

In the configuration of the entire outboard motor 100, an upper unit 101, a middle unit 102, and a lower unit 103 are arranged sequentially from the top. In the upper unit 101, an engine 1 is vertically mounted and supported by interposing an engine holder 101A such that its crankshaft 2 is oriented in a vertical direction. As the engine 1, any of various engines such as an in-line multi-cylinder engine may be employed. A cylinder block 4, a cylinder head 5, and a cylinder head cover 6 are sequentially combined with a crankcase 3 that supports the crankshaft 2. In the engine 1, a plurality of cylinders each having a cylinder axis line directed horizontally rearward are arranged to vertically overlap with each other. Further, the engine 1 is covered by an engine cover 100A.

The middle unit 102 is supported horizontally pivotably around a yawing axis set in a swivel bracket 106 using upper and lower mounts 104 and 105. A clamp bracket 107 is provided across the left and right sides of the swivel bracket 106, so that the engine 1 is fixed to a transom P of a ship hull using the clamp bracket 107. The swivel bracket 106 is supported vertically pivotably around a tilting shaft 108 set in the left-right direction.

In the middle unit 102, a driveshaft 109 connected to a lower end of the crankshaft 2 of the engine 1 is arranged to vertically penetrate, and a driving force of the driveshaft 109 is transmitted to a propeller shaft 111 disposed inside a gear casing 110 of the lower unit 103. A shift rod 112 configured to switch between forward and rearward travels is disposed in the front of the driveshaft 109 in parallel with the vertical direction. In addition, the middle unit 102 is provided with an oil pan or the like configured to store oil for lubricating the engine 1. Further, the middle unit 102 is provided with a driveshaft housing 113 configured to house the driveshaft 109.

In the lower unit 103, the gear casing 110 internally has a gear group 115 or the like configured to rotate and drive a propeller 114 by interposing a propeller shaft 111 using a driving force of the driveshaft 109. In the gear group 115, the driveshaft 109 extending downward from the middle unit 102 is installed with a gear meshing with a gear of the gear casing 110 to finally rotate the propeller 114. However, by manipulating a shift unit using the shift rod 112, a power transmission path of the gear group 115 inside the gear casing 110 is switched, that is, shifted.

According to this embodiment, the engine 1 is, for example, an in-line four-cylinder engine. As illustrated in FIG. 1, the engine has four cylinders including a first cylinder (#1), a second cylinder (#2), a third cylinder (#3), and a fourth cylinder (#4) arranged sequentially from the top. In the engine 1, the crankcase 3 is arranged in the front side, and the cylinder head 5 is arranged in the rear side. The engine 1 is mounted onto the engine holder 101A in the fourth cylinder (#4) side. In the crankcase 3 of the engine 1, the crankshaft 2 is supported rotatably inside the crankcase 3 by a plurality of journal bearings provided in the upper end, the middle, and the lower end. The lower end of the crankshaft 2 is also combined with an upper end of the driveshaft 109 by interposing a pair of connecting gears (reduction gears). As a result, rotary power of the crankshaft 2 is transmitted to the driveshaft 109.

The cylinder block 4 is internally provided with cylinder bores for each cylinder, and a piston is inserted into the cylinder bore reciprocatably (in this example, in the front-rear direction). The piston is connected to a crank pin of the crankshaft through a connecting rod. As a result, a reciprocating motion of the piston inside the cylinder bore is transformed to a rotating motion of the crankshaft 2, and the rotating motion is transmitted to the driveshaft 109 as the output power of the engine 1.

Although not specifically shown in the drawings, the cylinder head 5 is provided with a combustion chamber matching with the cylinder bore and intake and exhaust ports communicating with the combustion chamber for each cylinder. In this example, an intake system is disposed in the right side of the engine 1, and an exhaust system is arranged in the left side of the engine 1. In the intake system, an intake gas flows to an intake manifold while its flow rate is controlled by a throttle body arranged in the right side of the cylinder block 4. This intake gas is supplied to the intake port through an intake branch connected to each cylinder from the intake manifold. The intake port has a portion communicating with a combustion chamber controlled by an intake valve to be opened or closed.

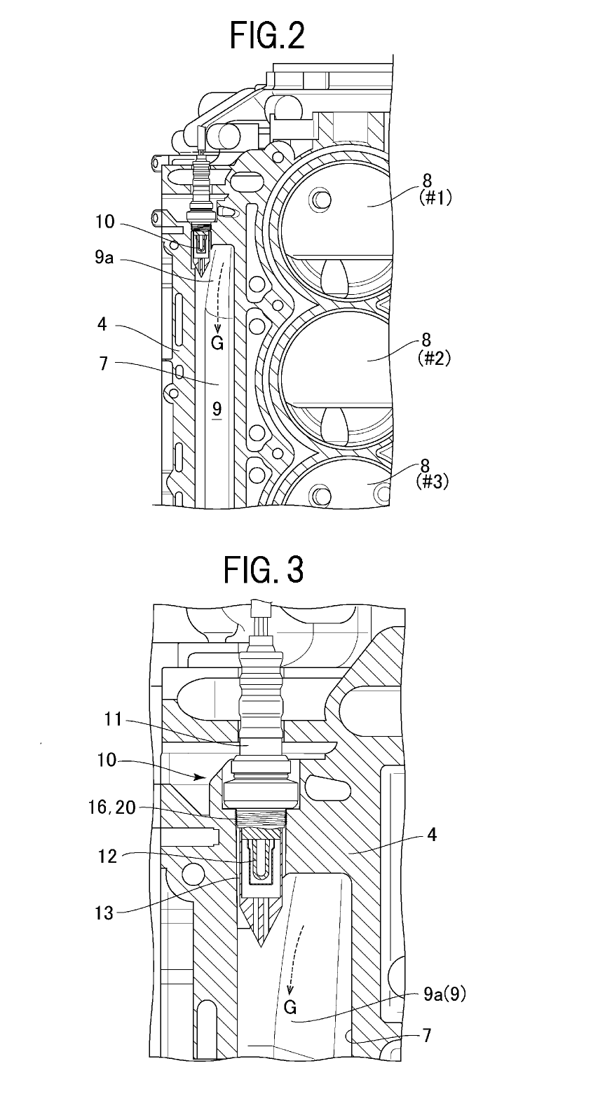

The exhaust port of the exhaust system has a portion communicating with the combustion chamber controlled by an exhaust valve to be opened or closed. An ignition plug is installed in a top portion of the combustion chamber in each cylinder, and the gas mixture supplied to the inside of the combustion chamber is ignited by the ignition plug. A combustion gas exploded or combusted inside the cylinder bore of each cylinder is discharged from the exhaust port to the exhaust manifold 7 of FIG. 1. As illustrated in FIG. 2, the exhaust port of each cylinder is connected to the exhaust manifold 7 provided outside of the cylinder bore 8 of the cylinder block 4. The exhaust gases (indicated by an arrow in FIG. 2 or the like as appropriate) discharged from the exhaust ports of each cylinder are joined in the exhaust manifold V. The confluent exhaust gas is finally guided to the lower side of the engine 1 through the exhaust manifold 7 and is further discharged to the water through an exhaust passage formed in the engine holder 101A.

However, in the engine 1 according to this embodiment, an oxygen sensor as an exhaust gas sensor described below is arranged in the middle of an exhaust flow path inside the exhaust manifold 7, and an oxygen concentration of the exhaust gas is detected using this oxygen sensor. As illustrated in FIG. 2, in this example, the oxygen sensor 10 is installed to approximately match the first cylinder (#1) in the middle of the exhaust flow path 9 inside the exhaust manifold 7. Here, the exhaust flow path 9 once extends in the horizontal direction (in FIG. 2, orthogonal to paper surface) from the combustion chamber of each cylinder through the exhaust port and then extends downward through a bend portion 9a bent downward. More specifically, as illustrated in FIG. 3, the oxygen sensor 10 is vertically installed in the bend portion 9a of the exhaust flow path 9 formed as described above approximately in parallel with the exhaust flow path, that is, the exhaust manifold 7.

Note that, although the oxygen sensor 10 is described as the exhaust gas sensor in this example, other sensors such as an air-fuel ratio (A/F) sensor or a NOx sensor may also be employed without limiting to the oxygen sensor.

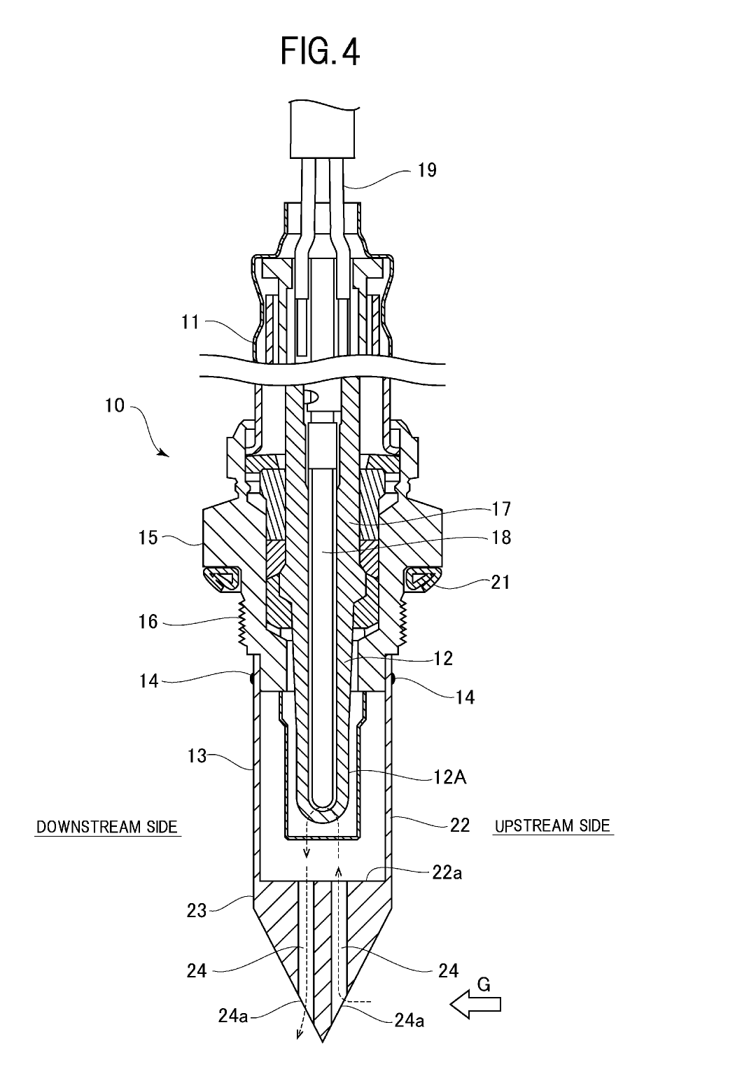

FIG. 4 illustrates an exemplary configuration of the oxygen sensor 10 according to this embodiment. The oxygen sensor 10 includes a casing 11 installed in the middle of the exhaust flow path 9 of the exhaust manifold 7 as an exhaust pipe, an oxygen concentration detector 12 installed in the casing 11 to detect an oxygen concentration of the exhaust gas flowing through the exhaust flow path 9, and a tubular protector 13 having a basal end side installed in the casing 11 by welding 14 or the like to cover the oxygen concentration detector 12.

The casing 11 forms an exterior shape of the oxygen sensor 10 and has a stepped tubular holder 15 integrally formed in the tip side of the casing 11. A male thread portion 16 for installation in the exhaust manifold 7 is formed in an outer circumference of the holder 15, and an oxygen concentration detector 12 is held inside the holder by interposing a sleeve 17 or the like. The oxygen concentration detector 12 is formed of a ceramic material such as zirconium oxides (ZrO₂) or yttria (Y₂O₃) to generate an electromotive force depending on the oxygen concentration of the exhaust gas. This electromotive force is output to an engine control unit (ECU) mounted to the outboard motor as an oxygen concentration detection signal. Further, the casing 11 is installed with a heater 18 configured to heat and activate the oxygen concentration detector 12. A lead wire 19 is connected to the oxygen concentration detector 12, so that the detection signal of the oxygen concentration detector 12 is output to the outside through the lead wire 19.

As illustrated in FIG. 3, the exhaust manifold 7 is provided with a female thread portion 20 screwed to the male thread portion 16 of the holder 15. By screwing the male thread portion 16 and the female thread portion 20 to each other, the oxygen sensor 10 can be installed in a predetermined position. In this case, a gasket 21 is nipped between the holder and the exhaust manifold 7 to maintain airtightness between the exhaust manifold 7 and the exhaust flow path 9.

The protector 13 includes a tubular portion 22 configured to house the detecting portion 12A of the oxygen concentration detector 12 in a bottomed hollow formed by blocking the tip side and an extension 23 configured to extend from a bottom 22a of the tubular portion 22 to the tip and provided with a plurality of channels 24 each communicating with an internal hollow portion of the tubular portion 22 and having an exhaust gas inlet port 24a opened to the outside in a radial direction.

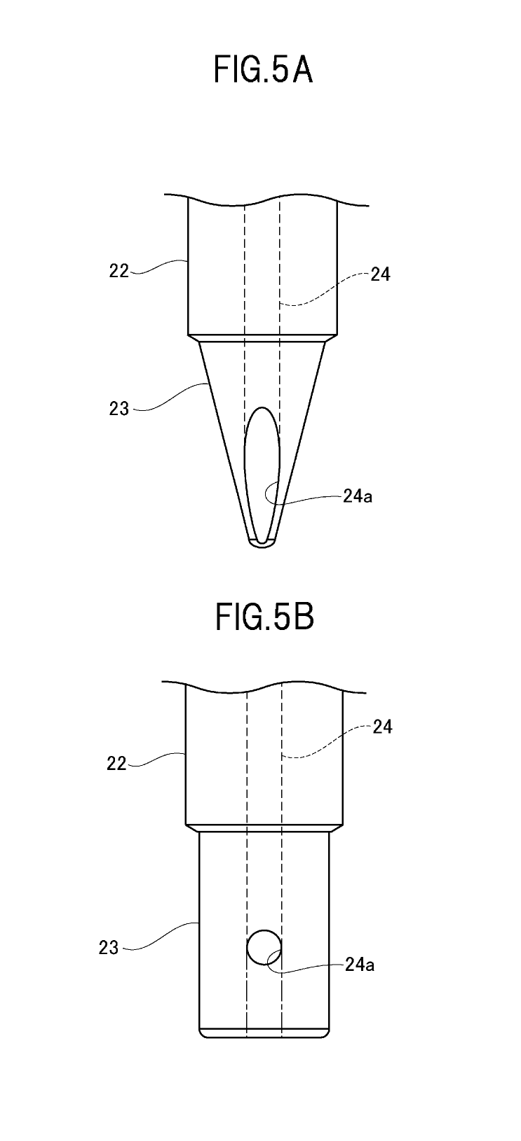

According to the present invention, the extension 23 of the protector 13 of the oxygen sensor 10 has a cylindrical tip formed in a conical shape as illustrated in FIG. 5A. The inlet port 24a of the channel 24 is opened on a circumferential surface of the conical shape. Note that the channel 24 is naturally formed in the axial direction of the cylinder.

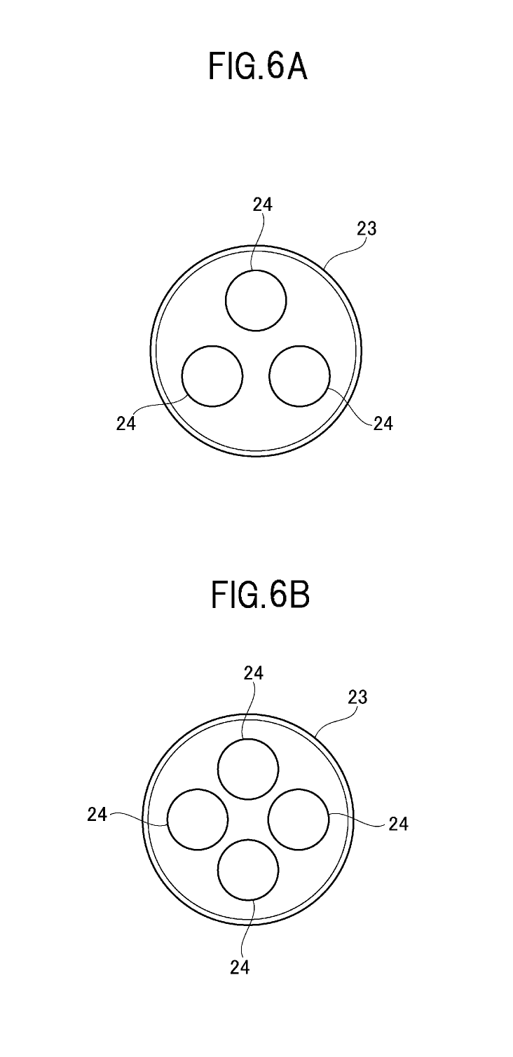

In the protector 13, the extension 23 is provided with a plurality of channels 24. Preferably, as illustrated in FIG. 6A, the extension 23 has three channels 24. In this case, the three channels 24 are arranged in circumferential positions obtained by dividing the circumference into three equal parts (at an angle of 120°) along a circumferential direction of the cylinder of the extension 23.

Alternatively, three or more channels 24 may also be provided. For example, four channels 24 are formed in the extension 23 as illustrated in FIG. 6B. In this case, the four channels 24 are arranged in circumferential positions obtained by dividing the circumference into four equal parts (at an angle of) 90° along the circumferential direction of the cylinder of the extension 23.

The extension 23 of the protector 13 has a cylindrical shape and is provided with a plurality of channels 24 formed along the axial direction of the cylinder as illustrated in FIG. 5B. In the vicinity of the tip portion of the extension 23, each channel is bent outward in the radial direction (perpendicularly) so that the inlet port 24a is opened on the circumferential surface of the cylinder. Alternatively, as indicated by the one-dotted chain line in FIG. 5B, each channel 24 may be formed up to the tip of the extension 23 and may be opened on the tip end surface.

Similarly, in this case, three or more channels 24 may be formed such that three or four channels 24 are arranged in circumferential positions obtained by dividing the circumference into three or four equal parts along the circumferential direction of the cylinder of the extension 23.

According to this embodiment, the oxygen sensor is connected to the ECU mounted onto the outboard motor 100, and its detection signal is transmitted to the ECU. The ECU drives and controls the injector or the ignition coil by determining operation values such as a fuel supply amount or an ignition timing, on the basis of the oxygen concentration information transmitted from the oxygen sensor 10, from a relationship with an intake air amount or an engine rotation number. For example, the ECU performs control such that the fuel such as gasoline increases in the case of an excessive supply of oxygen, and the fuel decreases in the case of a deficient supply of oxygen with respect to a remaining oxygen amount contained in the exhaust gas after burning at a theoretical air-fuel ratio. As a result, it is possible to stably maintain a proper air-fuel ratio.

In the oxygen sensor 10 according to the present invention, the exhaust flow path 9 of the exhaust manifold 7 and the internal hollow portion of the tubular portion 22 that houses the detecting portion 12A of the oxygen concentration detector 12 are connected to each other through a plurality of independent channels 24. When the oxygen concentration of the emission gas is detected using the oxygen concentration detector 12, a positive pressure of the exhaust gas is applied to the inlet port 24a of the channel 24 directed to the upstream side of the exhaust gas flow, and a negative pressure is applied to the inlet port 24a of the channel 24 directed to the downstream side of the exhaust gas flow as illustrated in FIG. 4. In this manner, by virtue of a pressure difference between the upstream-side and downstream-side channels 24 in the exhaust gas flow, the exhaust gas is introduced from the upstream-side channel 24 and flows to the internal hollow portion of the tubular portion 22 as indicated by the arrow G. Then, the exhaust gas arrives at the detecting portion 12A of the oxygen concentration detector 12 and is discharged from the downstream-side channel 24.

Inside the protector 13 of the oxygen sensor 10, a flow of the emission gas is formed to arrive at and flow to the detecting portion 12A of the oxygen concentration detector 12 with excellent efficiency, and a gas exchange of the emission gas in the oxygen concentration detector 12 is promoted. As a result, it is possible to prevent penetration of a water droplet by lengthening the channel 24. That is, since the gas exchange of the emission gas is promoted, the gas exchange property of the emission gas is sufficiently obtained as necessary even when the length of the channel 24 increases. Accordingly, it is possible to prevent penetration of a water droplet.

According to the present invention, the extension 23 of the protector 13 of the oxygen sensor 10 has a cylindrical tip formed in a conical shape, and the inlet port 24a of the channel 24 is opened on the circumferential surface of the conical shape. A projection area of the extension 23 is formed to decrease so that a resistance of the exhaust gas flowing inside the exhaust manifold 7 is reduced, and output loss of the engine 1 can be reduced. In addition, the projection area of the inlet port 24a of the channel 24 formed on the circumferential surface of the conical shape can increase in an exhaust gas flow direction as illustrated in FIG. 5A. Therefore, it is possible to improve exhaust gas inflow performance of the channel 24. Furthermore, the moisture attached on the extension 23 is collected in the conical tip to form a water droplet, and the water droplet drops down. Therefore, it is possible to prevent penetration of the water droplet into the channel 24.

The extension 23 is provided with three or more channels 24. For example, if three channels 24 are provided, typically, any channel 24 are arranged in the upstream side of the exhaust gas flow, and other channels are arranged in the downstream side of the exhaust gas flow as illustrated in FIG. 6A.

Since three or more channels 24 are provided in this manner, the channels 24 are dividingly arranged into the upstream and downstream sides in the exhaust gas flow, and the inlet ports 24a of the channels 24 are inevitably arranged in both the upstream and downstream sides of the exhaust gas flow. As described above, by screwing the male thread portion 16 of the holder 15 into the female thread portion 20 of the exhaust manifold 7, the oxygen sensors 10 are fixedly installed in predetermined positions. However, regardless of the circumferential fixing positions of the channels 24 defined by fastening the male thread portion 16, any one of the three channels is arranged in the upstream side of the exhaust gas flow. Regardless of the fastening condition of the male thread portion 16, it is possible to reliably form a proper exhaust gas flow path in which the exhaust gas is received from the upstream side and is discharged to the downstream side. Since an assembly work can be performed without considering the fixing position of the male thread portion 16 of the holder 15, it is possible to very efficiently perform the assembly work.

Here, in the outboard motor 100 fixed to a transom P of a ship hull, a water line or a water surface W is set in the vicinity of the upper part of the lower unit 103 as illustrated in FIG. 1. The oxygen sensor 10 installed in the engine 1 is positioned relatively higher than the water surface W. In this case, when the engine 1 stops, or when the engine rotation number is abruptly reduced, or the like, an internal space of the exhaust manifold 7 has a high negative pressure depending on an operation state of the engine 1, so that water may reversely flow to the exhaust passage above the exhaust manifold 7.

According to the present invention, in the engine 1 of the outboard motor 100 having the exhaust flow path 9 extending downward from the bend portion 9a bent downward, the protector 13 is installed approximately in parallel with the exhaust manifold 7 directed downward while a tip side of the protector 13 is positioned in the downside in the flow path of the bend portion 9a of the exhaust flow path 9. As a result, the inlet ports 24a of the channels 24 are clogged at the same time by the rising water level. Therefore, the channels 24 have an airlock structure, and the penetration of water is suppressed. Therefore, even in this case, it is possible to guarantee a proper operation of the oxygen sensor 10.

### Second Embodiment

Next, an oxygen sensor 10 according to a second embodiment of the invention will be described. Note that, in the following description, like reference numerals denote like elements as in the first embodiment. In this example, in particular, the protector 13 is detachably installed in the casing 11 and serves as an attachment for connecting the casing 11 and the exhaust manifold 7 to each other.

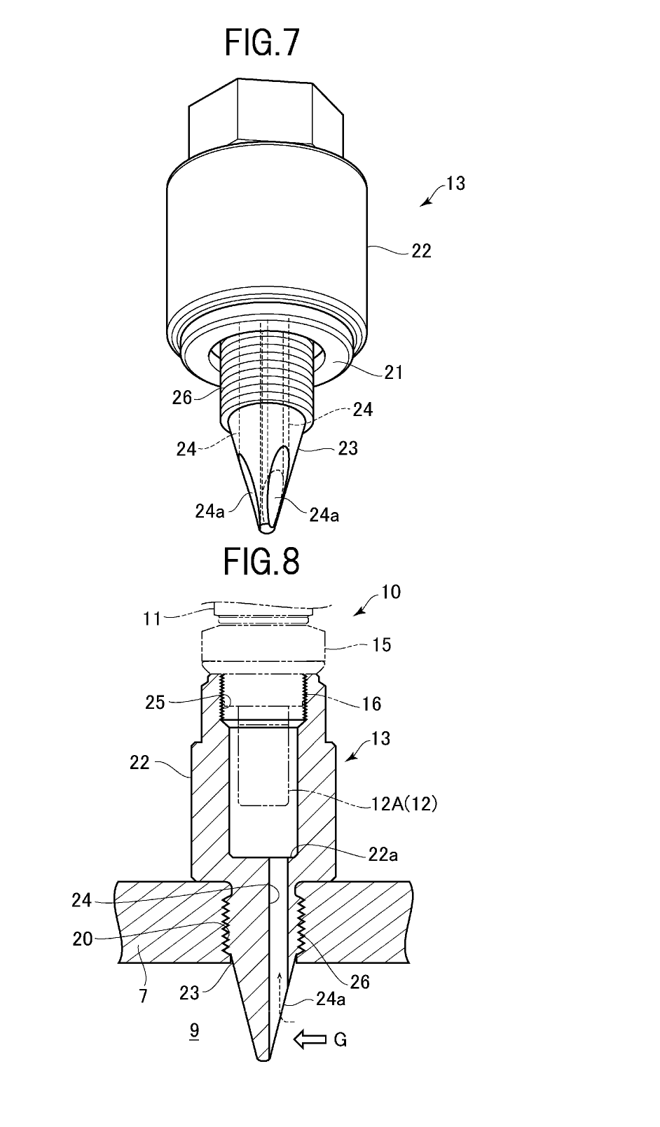

FIGS. 7 and 8 illustrate a specific configuration example of the oxygen sensor 10 according to the second embodiment of the invention. A casing 11 forms an exterior shape of the oxygen sensor 10 and has a holder 15 provided integrally in a tip side of the casing 11 in a stepped tubular shape. Although not shown specifically, a male thread portion 16 for installation in the protector 13 is provided in an outer circumference of the holder 15. An oxygen concentration detector 12 or the like similar to that of the first embodiment is held inside the holder 15. Similarly, in this case, a detection signal of the oxygen concentration detector 12 is output to the outside through a leading wire 19.

The protector 13 includes a tubular portion 22 configured to house a detecting portion 12A of the oxygen concentration detector 12 in a bottomed hollow formed by blocking the tip side and an extension 23 configured to extend from a bottom 22a of the tubular portion 22 to the tip and provided with a plurality of channels 24 each communicating with an internal hollow portion of the tubular portion 22 and having an exhaust gas inlet port 24a opened to outward in a radial direction.

According to the second embodiment, a female thread portion 25 screwed to the male thread portion 16 of the holder 15 is formed in an upper part of the tubular portion 22. The casing 11 and the protector 13 can be integrally combined with each other by screwing the male thread portion 16 and the female thread portion 25 to each other as illustrated in FIG. 8.

In addition, a male thread portion 26 screwed to the female thread portion 20 of the exhaust manifold 7 is formed in a base portion of the extension 23. The protector 13, that is, the oxygen sensor 10 can be installed in a predetermined position by screwing the male thread portion 26 and the female thread portion 20 to each other.

In this case, in the example of FIG. 7, a tip of the cylindrical shape of the extension 23 of the protector 13 is formed in a conical shape, and the inlet port 24a of the channel 24 is opened on a circumferential surface of the conical shape. Note that the channel 24 is naturally formed in the axial direction of the cylinder.

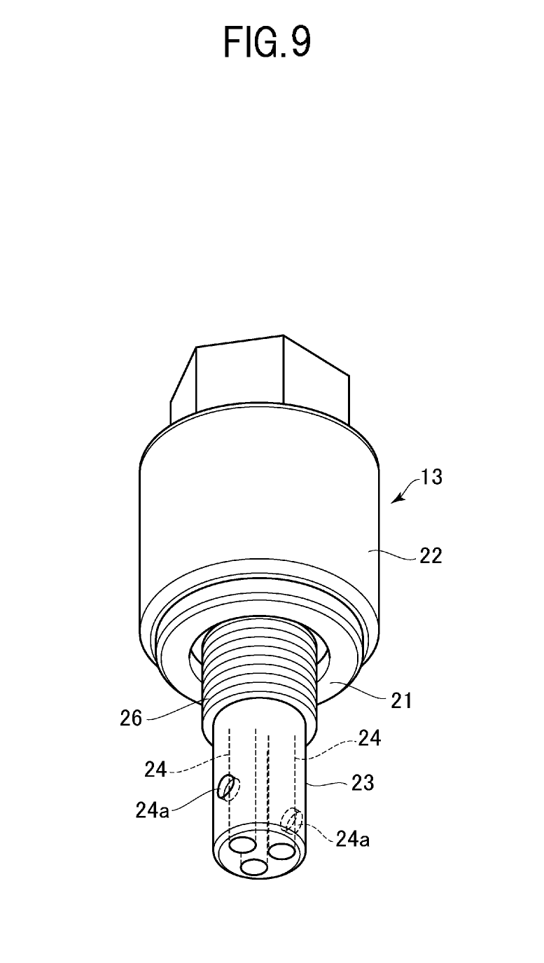

Similar to the example of FIG. 9, the extension 23 of the protector 13 has a cylindrical shape, and a plurality of channels 24 are formed in the axial direction of the cylinder. In the vicinity of the tip portion of the extension 23, each channel 24 is bent outward in the radial direction (perpendicularly), so that the inlet port 24a is opened on the circumferential surface of the cylinder.

In the case described above, in the example of FIG. 7 or 9, three channels 24 are provided. Alternatively, three or more channels 24 may also be formed. In addition, three or four channels 24 are arranged in circumferential positions obtained by dividing the circumference into three or four equal parts along a circumferential direction of the cylinder of the extension 23.

According to the second embodiment of the invention, inside the protector 13 of the oxygen sensor 10, a flow of the emission gas is formed to arrive at and flow to the detecting portion 12A of the oxygen concentration detector 12 with excellent efficiency, and a gas exchange of the emission gas in the oxygen concentration detector 12 is promoted. As a result, it is possible to prevent penetration of a water droplet by lengthening the channel 24.

According to the second embodiment of the invention, in particular, the protector 13 is detachably installed in the casing 11. The protector 13 can be separated from the casing 11 as a sensor body. Even when the channel 24 of the protector 13 is polluted, and fluidity of the exhaust gas is degraded, the protector 13 can be removed from the exhaust manifold 7 and cleaned appropriately. Since the protector 13 can be removed as necessary in this manner, it is possible to provide excellent operability or the like.

While preferred embodiments of the invention have been described and illustrated hereinbefore, it should be understood that they are only for exemplary purposes and are not to be construed as limitations. Any addition, omission, substitution, or modification may be possible without departing from the spirit or scope of the present invention.

Although the extension 23 of the protector 13 has a cylindrical tip formed in a conical shape by way of example in the embodiments described above, the tip of the extension 23 may also be formed in other shapes such as a pyramid or hemispherical shape.

Although the oxygen sensor 10 is installed to match the first cylinder #1 in the examples described above, the oxygen sensor 10 may also be installed to match the second cylinder #2 or any other subsequent cylinder.

Although the engine 1 is an in-line four-cylinder engine in the examples described above, the number of cylinders in the engine 1 may also change.

According to the present invention, inside the protector of the oxygen sensor, a flow of the emission gas is formed to arrive at and flow to the detecting portion of the oxygen concentration detector with excellent efficiency, and a gas exchange of the emission gas in the oxygen concentration detector is promoted. As a result, it is possible to lengthen the channel for guiding the exhaust gas to the oxygen concentration detector. Therefore, it is possible to prevent penetration of a water droplet to the oxygen concentration detector.

What is claimed is:

1. An exhaust gas sensor comprising:
a casing installed in the middle of a flow path of an exhaust pipe;
an oxygen concentration detector installed in the casing and configured to detect an oxygen concentration of an exhaust gas flowing through the flow path; and
a tubular protector having a basal end side installed in the casing to cover the oxygen concentration detector,
wherein the protector has
a tubular portion configured to house a detecting portion of the oxygen concentration detector in a bottomed hollow formed by blocking a tip side of the protector, and
an extension configured to extend from a bottom of the tubular portion to a tip and provided with a plurality of channels each communicating with an inner side of the tubular portion and having an exhaust gas inlet port opened outward in a radial direction.

2. The exhaust gas sensor according to claim 1, wherein the extension has a cylindrical tip formed in a conical shape, and
the inlet ports are opened on a circumferential surface of the conical shape.

3. The exhaust gas sensor according to claim 1, wherein the casing has a male thread portion formed in an outer circumference of a stepped tubular holder of the tip side for installation in the exhaust pipe, and
the protector is provided with at least three channels in the extension.

4. The exhaust gas sensor according to claim 1, wherein the protector is detachably installed in the casing and serves as an attachment for connecting the casing and the exhaust pipe to each other.

5. An outboard motor engine comprising:
a crankshaft having an axial line oriented in a vertical direction;
a plurality of cylinders arranged vertically overlappingly;
an exhaust flow path formed to extend from a combustion chamber in a horizontal direction and then be bent downward for discharging an exhaust gas to water; and
an exhaust gas sensor provided with
a casing installed in the middle of a flow path of an exhaust pipe,
an oxygen concentration detector installed in the casing and configured to detect an oxygen concentration of an exhaust gas flowing through the flow path, and
a tubular protector having a basal end side installed in the casing to cover the oxygen concentration detector, the protector being approximately in parallel with an exhaust pipe directed downward while a tip side of the protector being directed downward in the flow path of the bend portion of the exhaust flow path,
wherein the protector has
a tubular portion configured to house a detecting portion of the oxygen concentration detector in a bottomed hollow formed by blocking a tip side of the protector, and
an extension configured to extend from a bottom of the tubular portion to the tip and provided with a plurality of channels each communicating with an inner side of the tubular portion and having an exhaust gas inlet port opened outward in a radial direction.
